(19) United States
(12) Patent Application Publication
(10) Pub. No.: US 2024/0297454 A1
(43) Pub. Date: Sep. 5, 2024

(54) CONNECTOR AND ELECTRICAL DEVICE

(71) Applicant: SHENZHEN TOP-LINK TECHNOLOGIES CO., LTD., Shenzhen (CN)

(72) Inventors: Zengshi MA, Shenzhen (CN); Lan XIAO, Shenzhen (CN); Donglin LI, Shenzhen (CN)

(73) Assignee: SHENZHEN TOP-LINK TECHNOLOGIES CO., LTD., Shenzhen (CN)

(21) Appl. No.: 18/658,705

(22) Filed: May 8, 2024

Related U.S. Application Data
(63) Continuation of application No. PCT/CN2022/084876, filed on Apr. 1, 2022.

(30) Foreign Application Priority Data
Sep. 30, 2021 (CN) 202111169244.9

(51) Int. Cl. H01R 13/193; H01R 13/04; H01R 13/10; H01R 13/622

(52) U.S. Cl. CPC H01R 13/193; H01R 13/04; H01R 13/10; H01R 13/622

(57) ABSTRACT

Disclosed are a connector and an electrical device. The connector includes: a female end, a male end, a collar component, and a pushing member. The female end is formed with a docking cavity; the male end includes a pin; the collar component is provided in the docking cavity or sleeved on a periphery of the pin, and the collar component includes a first annular component and a second annular component; the pushing member is provided on the pin or the female end; in response to that the pin is plugged into the docking cavity and the collar component is pushed at the docking cavity by the pushing member, the first annular component is configured to contract inward to be tightly cooperated with the pin, and the second annular component is configured to expand outward to be tightly cooperated with an inner wall of the docking cavity.

### CROSS-REFERENCE TO RELATED APPLICATIONS

The present application is a continuation application of International Application No. PCT/CN2022/084876, filed on Apr. 1, 2022, which claims priority to Chinese Patent Application No. 202111169244.9, filed on Sep. 30, 2021. The disclosures of the above-mentioned applications are incorporated herein by reference in their entireties.

### TECHNICAL FIELD

The present application relates to the technical field of connectors, and in particular to a connector and an electrical device.

### BACKGROUND

With the development of the times, users have higher requirements for the current carrying capacity of connectors. The current-carrying bottleneck of the conventional structural connectors is mostly at the abutting interface, which is mostly point abutting or line abutting. The effective abutting point or the abutting surface of the abutting interface is limited, and the current-carrying capacity of the product is limited, making it difficult for significant improvement.

### SUMMARY

The main purpose of the present application is to provide a connector and an electrical device, aiming to achieve the strong current carrying capacity of the connector.

In order to achieve the above purpose, the present application provides a connector, including:
a female end formed with a docking cavity;
a male end including a pin;
a collar component provided in the docking cavity or sleeved on a periphery of the pin, the collar component includes a first annular component and a second annular component;
a pushing member provided on the pin or the female end;
in response to that the pin is plugged into the docking cavity and the collar component is pushed at the docking cavity by the pushing member, the first annular component and the second annular component are configured to squeeze each other, the first annular component is configured to contract inward to be tightly cooperated with the pin, and the second annular component is configured to expand outward to be tightly cooperated with an inner wall of the docking cavity.

In an embodiment, an outer diameter of the first annular component is less than an outer diameter of the second annular component.

In an embodiment, the first annular component is independent from the second annular component, and both the first annular component and the second annular component are provided with a fracture.

In an embodiment, before the collar component is pushed by the pushing member, the first annular component is in an open-loop state; and
in response to that the collar component is pushed by the pushing member, the second annular component is in an open-loop state.

In an embodiment, one side of the first annular component facing away from the pin is formed with a slope or an arc surface, one side of the second annular component towards the pin is formed with a slope or an arc surface, the slope of the first annular component is adapted to be abutted against the slope of the second annular component, or the arc surface of the first annular component is adapted to be abutted against the arc surface of the second annular component.

In an embodiment, one side of the collar component towards the pushing member is formed with a slope or an arc surface, and one side of the pushing member towards the collar component is formed with a slope or an arc surface cooperated with the collar component.

In an embodiment, in a cross-section parallel to an axial direction of the pin, a cross-section of the first annular component is circular, elliptical or polygonal, and/or a cross-section of the second annular component is circular, elliptical or polygonal.

In an embodiment, in response to that the collar component is pushed by the pushing member, a gap is maintained between the first annular component and the docking cavity, and a gap is maintained between the second annular component and the pin.

In an embodiment, in response to that a pushing force on the collar component by the pushing member is canceled, the first annular component is configured to expand and the second annular component is configured to contract.

In an embodiment, before the collar component is pushed by the pushing member, a distance between a cross-sectional center of the first annular component and a center of the first annular component is less than a distance between a cross-sectional center of the second annular component and a center of the second annular component.

In an embodiment, the pushing member is fixed to the periphery of the pin; or
the pushing member is movably installed on the pin along an axial direction of the pin; or
the pushing member is movably installed on the female end along an axial direction of the docking cavity.

In an embodiment, the pin is provided with a front end and a rear end, the pushing member is closer to the rear end of the pin than to the front end of the pin, a stopping platform is provided on a sidewall of the front end of the pin, and the collar component is provided between the pushing member and the stopping platform.

In an embodiment, a stopping platform is protrudingly provided on a sidewall of the docking cavity, and the collar component is provided between the pushing member and the stopping platform.

In an embodiment, one side of the collar component towards the stopping platform is formed with a slope or an arc surface, and one side of the stopping platform is formed with a slope or an arc surface adapted to the collar component.

In an embodiment, at least two first annular components are provided, at least two second annular components are provided, and the first annular component and the second annular component are alternately provided along the axial direction of the pin.

In an embodiment, the collar component is made of copper or copper alloy, silver or silver alloy, aluminum or aluminum alloy or stainless steel.

The present application also provides an electrical device including the connector.

In the technical solution of the present application, the female end of the connector is formed with a docking cavity, and the male end includes the pin. The collar component is provided in the docking cavity or sleeved on the periphery of the pin. The collar component includes a first annular component and a second annular component, and the pushing member is provided at the pin or at the female end. When the pin is plugged in the docking cavity and the collar component is pushed by the pushing member in the docking cavity, the first annular component squeezes the second annular component. The first annular component contracts inward to be tightly matched withed with the pin, and the second annular component expands outward to be tightly matched with the inner wall of the docking cavity. The present application achieves the stable and strong current carrying capacity of the connector.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a connector according to an embodiment of the present application.

FIG. 2 is an exploded view of FIG. 1.

FIG. 3 is a cross-sectional view of FIG. 1.

FIG. 4 is a schematic structural view of a collar component before being pushed according to an embodiment of the present application.

FIG. 5 is a schematic structural view of the collar component being pushed according to an embodiment of the present application.

FIG. 6 is a schematic structural view of the connector according to an embodiment of the present application.

FIG. 7 is a front view of FIG. 6.

FIG. 8 is an exploded view of FIG. 7.

FIG. 9 is a cross-sectional view of FIG. 8.

FIG. 10 is a schematic structural view of a first annular component according to an embodiment of the present application.

FIG. 11 is a schematic structural view of a second annular component according to an embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. In addition, the technical solutions between the various embodiments can be combined with each other, but must be based on the realization by those of ordinary skill in the art. When the combination of technical solutions is contradictory or cannot be realized, it should be considered that the combination of such technical solutions does not exist or fall within the scope of protection claimed in this application.

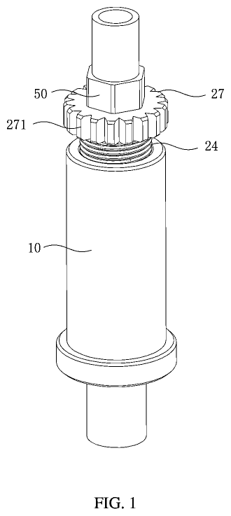

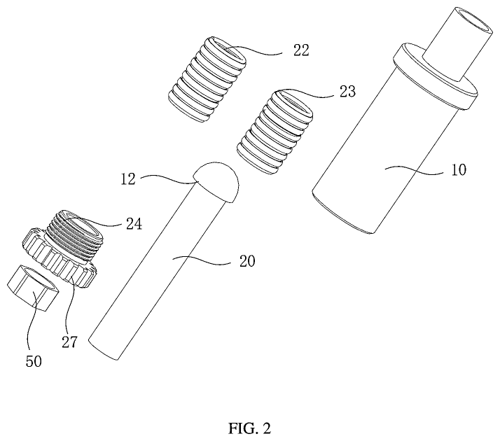

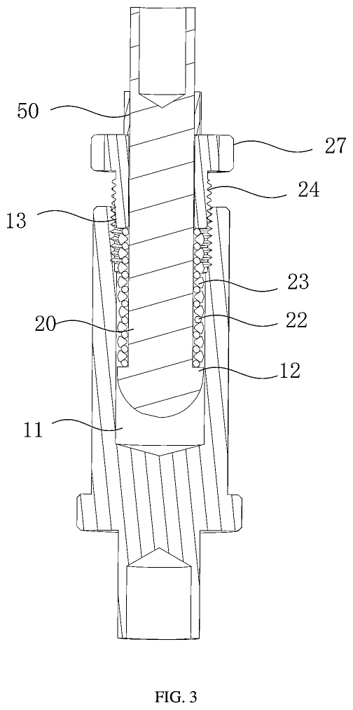

Referring to FIG. 1, FIG. 2 and FIG. 3, in an embodiment, the connector includes: a female end 10, a male end, a collar component, and a pushing member 24.

The female end 10 is formed with a docking cavity 11. The female end 10 can be formed as a whole conductor, and a through hole or a blind hole structure is provided on the female end 10 to form the docking cavity 11. The through hole or the blind hole can also be provided on the female end 10, a conductor structure is provided in the through hole or the blind hole, and the cavity formed inside the conductor structure serves as the docking cavity 11. One end of the female end 10 facing away from the docking cavity 11 is provided with a plugging groove, and the plugging groove is connected to a high current cable.

The male end includes a pin 20 configured to be at least partially plugged in the docking cavity 11, and the pin 20 includes a front end and a rear end. The front end of the pin 20 is plugged into the docking cavity 11 as the plugging end, so that the male end is docked with the female end 10. The pin 20 can be the conductor as a whole, or the conductor can be provided only at part of the inner wall of the docking cavity 11 where an electric shock is formed. The size and shape of the pin 20 are adapted to the docking cavity 11. One end of the male end facing away from the pin 20 is opened with another plugging groove, and the plugging groove is connected to the high current cable.

The collar component is provided in the docking cavity 11 or sleeved on the periphery of the pin 20. The collar component includes a first annular component 22 and a second annular component 23.

The pushing member 24 is provided at the periphery of the pin 20 or at the female end 10. The pushing member 24 is configured to push the collar component toward the inside of the docking cavity 11. When the collar component is pushed by the pushing member 24, the first annular component 22 squeezes the second annular component 23. The first annular component 22 contracts inward to be tightly matched with the male end, and the second annular component 23 expands outward to be tightly matched with the inner wall of the docking cavity 11. The pushing member 24 is fixed to the periphery of the pin 20, or the pushing member 24 is movably installed at the pin 20 along the axial direction of the pin 20, or the pushing member 24 is movably installed at the female end 10 along the axial direction of the docking cavity 11.

It should be noted that the position where the docking cavity 11, the pin 20 and the collar component are pushed by the pushing member 24 to form a abutting point must be conductive, that is, when the male end is connected to the female end 10, and the male end and the female end 10 are respectively connected to the high current cable, the current can flow among the pin 20, the first annular component 22, the second annular component 23, and the docking cavity 11. The pushing member 24 can be a conductor structure or a non-conductor structure. Of course, in order to increase the abutting points between the male end and the female end 10 as much as possible, the pushing member 24 is usually the conductor structure. There are many ways for the docking cavity 11, the pin 20, the collar component and even the pushing member 24 to achieve the conductive function. For example, conductive coating can be applied to the surfaces of these components. The conductive coating is composed of well-dispersed nano conductive graphite coating particles, which can provide excellent conductive performance and can greatly reduce the abutting resistance between the positive and negative electrode materials and the current collector, thus greatly improving the conductive performance of the positive and negative electrode materials. Of course, each component can also be made of conductive materials directly to make it conductive. The former is more economical and affordable in terms of production costs.

It should also be noted that the conductive materials of each component, such as the first annular component 22 and the second annular component 23, can be made of copper or copper alloy, silver or silver alloy, aluminum or aluminum alloy or stainless steel with relatively high conductivity. Among the good metals, silver has the best conductivity, followed by copper. However, because silver is more expensive, copper or copper alloys with higher conductivity are generally used.

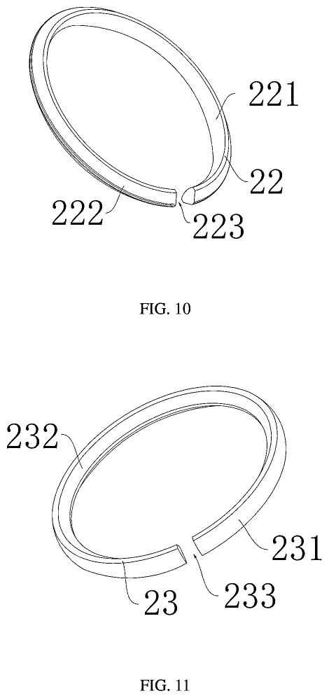

Referring to FIG. 10 and FIG. 11, the first annular component 22 and the second annular component 23 are independently provided, and the first annular component 22 and the second annular component 23 are respectively provided with a fracture 223 and a fracture 233. The fracture 223 and the fracture 233 on the first annular component 22 and the second annular component 23 improve the deformability of the two annular components.

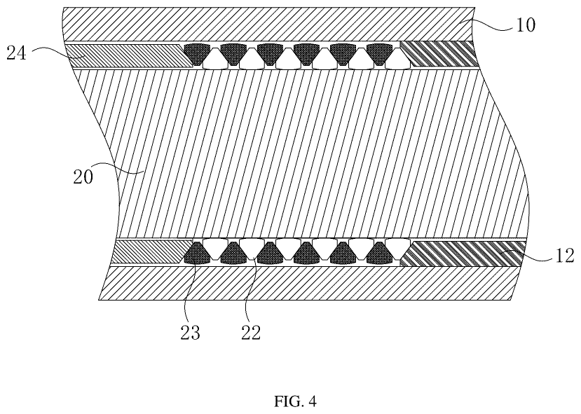

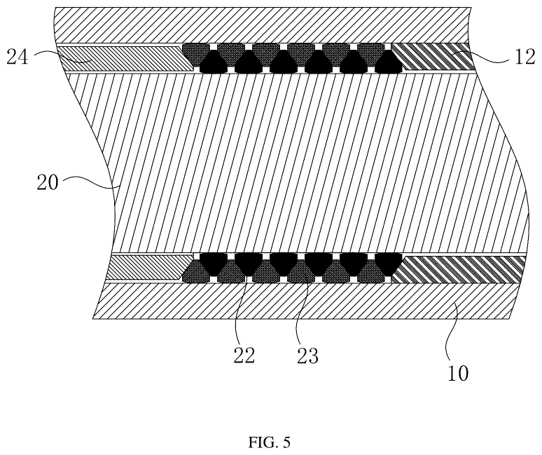

Referring to FIG. 4 and FIG. 5, before the collar component is pushed by the pushing member 24, the first annular component 22 is in an open-loop state. When the collar component is pushed by the pushing member 24, the first annular component 22 and the second annular component 23 are pushed toward the inside of the docking cavity 11 through the pushing member 24. Under the extrusion of the pushing member 24, the first annular component 22 is pressed with the second annular component 23. The first annular component 22 contracts inward, and the second annular component 23 expands outward, until the first annular component 22 is at least partially abutted against the pin 20, the second annular component 23 is at least partially abutted against the inner wall of the docking cavity 11, and the first annular component 22 is at least partially abutted against the second annular component 23. At this time, the second annular component 23 is in the open-loop state, there is a gap between the first annular component 22 and the docking cavity 11, and there is a gap between the second annular component 23 and the pin 20. Since the pin 20, the first annular component 22, the second annular component 23 and the abutting point of the docking cavity 11 of the female end 10 are all conductors, when the connector is in the working state, the current flows along the pin, the inner loop, the outer loop and the wall of the docking cavity for transmission, realizing high current shunting and resuming to complete high current connection. When the male end is separated from the female end 10, the pushing member 24 moves along the axial direction of the pin 20 away from the female end 10. The pushing force disappears, the inner outer loop rebounds and resets, and the pin 20 is in a gap fit or a transition fit with the inner wall of the docking cavity 11. At this time, the pin 20 can be pulled out with a relatively small force.

Referring to FIG. 4 and FIG. 5, the number of the first annular component 22 and the second annular component 23 can be determined according to the size of the gap between the docking cavity 11 and the pin 20 and the width of the first annular component 22 and the width of the second annular component 23. The first annular component 22 may be one or more, and the second annular component 23 may also be one or more. In order to increase the abutting points between the male end and the female end 10 as much as possible, in an embodiment, at least two first annular components are provided, at least two second annular components are provided, and the first annular component and the second ring-shaped components are alternately provided along the axial direction of the pin.

When at least two second annular components 23 are provided, at least two abutting points are formed through the cooperation of the first annular component 22 and the second annular component 23, so that the current carrying stability of the connector is further improved. At this time, the arrangement sequence of the first annular component 22 (A) and the second annular component 23 (B) is not particularly specified, and can be AABBAA, ABABAB, ABAABB, BBAABB, BABABA, BABBAA. When the arrangement sequence of the two annular components is AABBAA and the collar component is pushed by the pushing member 24, the adjacent first annular component 22 is pushed by the pushing member 24 to contract to be abutted against the outer wall of the pin 20, the adjacent first annular component 22 is pushed by the pushed first annular component 22 to contract to be abutted against the outer wall of the pin 20, the adjacent second annular component 23 is pushed by the pushed first annular component 22 to expand outward to be abutted against the inner wall of the docking cavity 11, the adjacent second annular component 23 is pushed by the pushed second annular component 23 to expand outward to be abutted against the inner wall of the docking cavity 11, the adjacent first annular component 22 is pushed by the pushed second annular component 23 to contract inward to be abutted against the outer wall of the pin 20, and the adjacent first annular component 22 is pushed by the pushed first annular component 22 to contract inward to be abutted against the outer wall of the pin. Other arrangement sequences can be deduced according to the same rules, which will not be described here. The working principle of the annular component in a special arrangement sequence will be explained in detail below.

In order to increase the connection points between the female end 10 and the male end as much as possible, the first annular component 22 and the second annular component 23 are alternately provided along the axial direction of the pin 20, which is ABABAB or BABABA. When the arrangement sequence of the two annular components is ABABAB and the collar component is pushed by the pushing member 24, the first annular component 22 is pushed by the pushing member 24, and the first annular component 22 contracts inward to be abutted against the outer wall of the pin 20. The adjacent second annular component 23 is pushed by the pushed first annular component 22 to expand outward to be abutted against the inner wall of the docking cavity 11, and the adjacent first annular component 22 is pushed by the pushed second annular component 23 to contract inward until it abuts against the outer wall of the pin 20. The subsequent first annular component 22 and the second annular component 23 respectively repeat the working principle of the previous first annular component 22 and the second annular component 23, and respectively contract inward to be abutted against the outer wall of the pin 20 and expand outward to be abutted against the inner wall of the docking cavity 11. When the arrangement sequence of the two annular components is ABABAB, the second annular component 23 is pushed by the pushing member 24 to expand outward until it abuts against the inner wall of the docking cavity 11. The first annular component 22 is pushed by the pushed second annular component 23 to contract inward until it abuts against the outer wall of the pin 20, and the second annular component 23 is pushed by the pushed first annular component 22 to expand outward to abut against the inner wall of the docking cavity 11. The subsequent annular component repeats the working principle of the previous annular component.

Through the mutual cooperation of the first annular component 22 and the second annular component 23, at least two abutting points are formed between the pin 20 and the docking cavity 11. The pin 20 has radial multi-abutting shunting and strong current carrying capacity, which can carry current from tens to hundreds of amps or even thousands of amps. By making radial line abutting, point abutting or even surface abutting coexist, the current carrying capacity of a single channel is greatly improved and the product size is reduced. The number of abutting inner loops and outer loops can be appropriately matched based on product requirements to achieve product functional diversity.

There are no special requirements on the shape and size of the first annular component 22 and the second annular component 23. The projection of the axis vertical plane of the first annular component 22 and the second annular component 23 can be a circular fracture, a regular fracture polygon or an irregular fracture polygon. The shape of the annular component can be selected according to the shape of the pin 20 and the shape of the docking cavity 11. Of course, generally speaking, the pin 20 will be in a cylindrical shape, and at this time, the annular component will usually be in a fractured ring shape.

There are many choices for the size of the first annular component 22 and the second annular component 23. In order to explain this in detail more conveniently, the annular component in the fractured ring shape is taken as an example. The outer diameter of the first annular component 22 can be less than, equal to, or even greater than the outer diameter of the second annular component 23. The key is that when the first annular component 22 and the second annular component 23 are pushed by each other, the first annular component 22 needs to exert a force to the second annular component 23 towards the inner wall of the docking cavity 11 and away from the outer wall of the pin 20, and the second annular component 23 needs to exert a force to the first annular component 22 towards the outer wall of the pin 20 and away from the inner wall of the docking cavity 11. In order to make it easier for the first annular component 22 to contract inward and the second annular component 23 to expand outward when the collar component is pushed. In an embodiment, the outer diameter of the first annular component 22 is less than the outer diameter of the second annular component 23. Since the outer diameter of the first annular component 22 is less than the outer diameter of the second annular component 23, when the collar component is pushed, the pushing force exerted on the first annular component 22 and the second annular component 23 will generate a pressure in each radial direction, so that the first annular component 22 is easy to contract inward, and the second annular component 23 is easy to expand outward.

Similarly, in order to make the first annular component 22 more easily to contract and make the second annular component 23 more easily to expand when the first annular component 22 and the second annular component 23 push against each other. In an embodiment, before the collar component is pushed by the pushing member 24, the distance between the cross-sectional center of the first annular component 22 and the center of the first annular component 22 is less than the distance between the cross-sectional center of the second annular component 23 and the center of the second annular component 23.

Referring to FIG. 10 and FIG. 11, based on the above embodiment, in order to increase the abutting area between the first annular component 22 and the second annular component 23 and to increase the connection points between the female end and the male end, the first annular component 22 is formed with an inner docking surface 221, which is at least partially abutted on the periphery of the pin 20. The second annular component 23 is formed with an outer docking surface 231, and the outer docking surface 231 is at least partially abutted on the inner wall of the docking cavity 11. The first annular component 22 is abutted against the second annular component 23, so that the pin 20 is connected to the inner wall of the docking cavity 11 through the first annular component 22 and the second annular component 23.

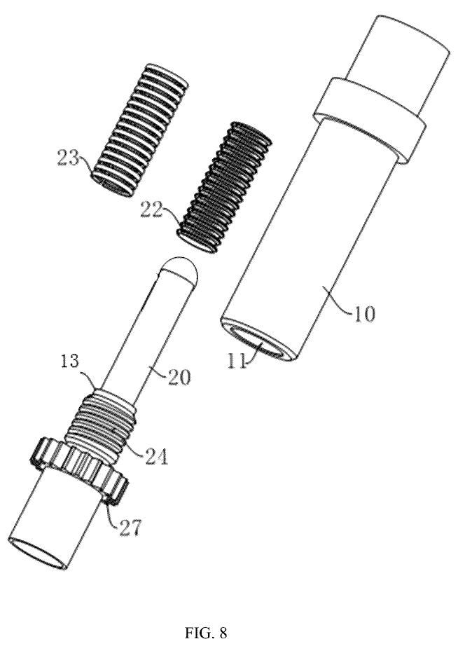

Please refer to FIG. 3 and FIG. 8, the abutting between the first annular component 22 and the second annular component 23 can be a point-to-point abutting, a point-to-surface abutting, or a surface-to-surface abutting. In order to make full use of the gap between the pin 20 and the inner wall of the docking cavity 11 and improve space utilization, the surface-to-surface abutting is generally used. In an embodiment, the side of the first annular component 22 facing away from the pin 20 is formed with a slope 222 or an arc surface, and the side of the second annular component 23 towards the pin 20 is formed with a slope 232 or an arc surface. The slope 222 of the first annular component 22 and the slope 232 of the second annular component 23 are adapted to abut, or the arc surface of the first annular component 22 and the arc surface of the second annular component 23 are adapted to abut. The way to set the slope or the arc surface can increase the contact area between the first annular component 22 and the second annular component 23, thereby increasing the connection points between the male end and the female end 10.

In addition, since the collar component is pushed by the pushing member 24, when the pushing member 24 applies the pushing force to the collar component, in order to make the collar component better adapt to the pushing member 24, in an embodiment, one side of the collar component towards the pushing member 24 is formed with a slope or an arc surface, and one side of the pushing member 24 towards the collar component is formed with a slope or an arc surface cooperated with the collar component. The pushing member 24 may be adapted to the first annular component 22 or the second annular component 23.

In the cross-section parallel to the axial direction of the pin, the cross-sections of the first annular component 22 and the second annular component 23 parallel to the axial direction may be in a circular, an elliptical or a polygonal structure, as long as the first ring-shaped component 22 can exert a force on the second annular component 23 in the direction away from the outer wall of the pin 20, and the second annular component 23 can exert a force on the first annular component 22 towards the outer wall of the pin 20.

Please refer to FIG. 1, FIG. 2 and FIG. 3. In an embodiment, the pushing member 24 is sleeved on the pin 20, and the pushing member 24 is configured to move along the axis of the pin 20. At this time, the pushing member 24 can be sleeved on the periphery of the pin 20 in the form of a threaded member, or can be directly provided on the outer wall of the pin 20 in the form of a threaded surface.

In the above embodiment, in order to fix the pushing member 24, a locking member 13 is provided on the female end. The locking member 13 is cooperated with the pushing member 24, so that the pushing member 24 can be connected to the locking members 13. The pushing member 24 can be detachably connected to the locking member 13 to achieve quick disassembly and assembly. When the locking member 13 is an internal thread provided on the inner wall of the docking cavity 11, the locking member 13 may be provided near the mouth of the docking cavity 11, near the bottom of the cavity, or in the middle of the docking cavity 11. When the locking member 13 is near the mouth of the docking cavity 11, the pushing member 24 can be sleeved on the rear end of the pin 20 or provided on the rear end of the pin 20 in the form of a threaded surface. When the locking member 13 is provided in the middle of the docking cavity 11 and the pushing member 24 is sleeved on the outer wall of the pin 20, the length of the pushing member 24 needs to make the middle of the docking cavity 11 abutted. At this time, the pushing member 24 can also be provided in the middle of the outer wall of the pin 20 in the form of a threaded surface. When the locking member 13 is provided on the inner wall of the docking cavity 11 near the bottom of the cavity, in order to save the space of the docking cavity 11 as much as possible, the pushing member 24 is often provided in the form of the threaded surface on the front end of the outer wall of the pin 20.

When the pushing member 24 is pushed against the docking cavity 11, the external threads on the pushing member 24 are connected with the internal threads on the inner wall of the docking cavity 11, and the pushing member 24 is fixed to the female end 10, so as to prevent the pushing member 24 from being pushed out of the docking cavity 11 by the collar component.

Referring to FIG. 1 and FIG. 2, in order to limit the displacement of the pushing member 24, the connector also includes a limiting ring 50. The limiting ring 50 is sleeved on the outer wall of the pin 20, and is provided on the side of the pushing member 24 away from the collar component. The limiting ring 50 may be configured to block the pushing member 24 from moving in the axial direction of the pin 20. When making the pin 20, an external thread surface can be provided on the outer surface of the pin 20, and an internal thread surface can be provided on the inner surface of the limiting ring 50, so that the limiting ring 50 can be threadedly cooperated with the pin 20, which limits the pushing member 24. When the pushing member 24, the pin 20 and the locking member 13 are threadedly cooperated, the limiting ring 50 can lock the pushing member 24 at the same time.

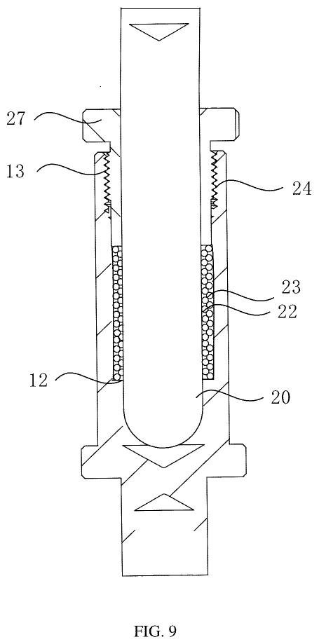

Referring to FIG. 9, in an embodiment, a stopping platform 12 is provided on the inner wall of the docking cavity 11. The stopping platform 12 is protrudingly provided on the sidewall of the docking cavity 11, and the collar component is provided between the pushing member 24 and the stopping platform 12. The inner diameter of the stopping platform 12 is less than the maximum peripheral diameter of the first annular component 22 and the second annular component 23, and the outer diameter of the stopping platform 12 is greater than the maximum peripheral diameter of the first annular component 22 and the second annular component 23. When the first annular component 22 and the second annular component 23 are pushed into the docking cavity 11 by the pushing member 24, the stopping platform 12 may be abutted against the first annular component 22 or the second annular component 23 on one side away from the pushing member 24. The stopping platform 12 is cooperated with the pushing member 24 to limit the first annular component 22 and the second annular component 23 in two directions, so that the first annular component 22 and the second annular component 23 are blocked, and the first annular component 22 is abutted against the second ring-shaped component 23. The pushing member 24 is configured to push the first annular component 22 and the second annular component 23 to move toward the front end direction of the pin 20.

Referring to FIG. 3, in an embodiment, the stopping platform 12 is provided on the sidewall of the front end of the pin 20, and the collar component is provided between the pushing member 24 and the stopping platform 12. The stopping platform 12 is protrudingly provided at the front end of the pin 20, and the outer diameter of the stopping platform 12 is greater than the maximum periphery diameter of the first annular component 22 and the second annular component 23. When the first annular component 22 and the second annular component 23 are pushed into the docking cavity 11 by the pushing member 24, the stopping platform 12 may be abutted against the first annular component 22 or the second annular component 23 on one side away from the pushing member 24. The stopping platform 12 is cooperated with the pushing member 24 to limit the first annular component 22 and the second annular component 23 in two directions, so that the first annular component 22 and the second annular component 23 are blocked, and the first annular component 22 is abutted against the second ring-shaped components 23.

In order to facilitate the cooperation between the stopping platform 12 and the collar component, a slope or an arc surface is formed on the side of the collar component towards the stopping platform 12, and a slope or an arc surface is formed on the side of the stopping platform 12 towards the collar component to adapt to the collar component. The stopping platform 12 may be adapted to the first annular component 22 or the second annular component 23.

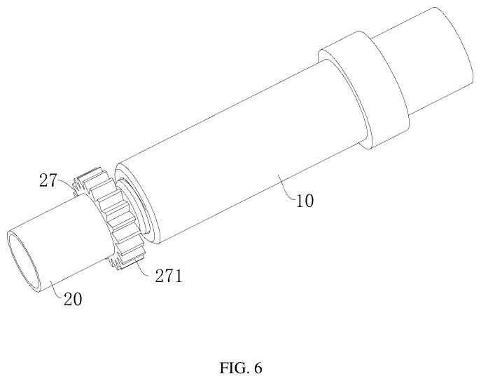

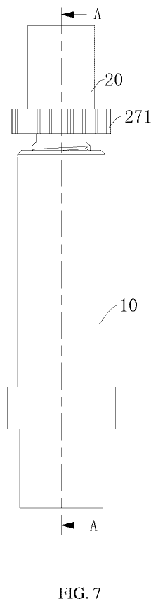

Please refer to FIG. 6 and FIG. 7, in order to facilitate disassembly and assembly, in an embodiment, an installation portion 27 is protrudingly provided on the periphery of the pin 20. The installation portion 27 is closer to the rear end of the pin 20 than the pushing member 24. After the first annular component 22, the second annular component 23 and the corresponding pin 20 are plugged into the docking cavity 11, the installation portion 27 is provided outside the female end 10. The first annular component 22 and the second annular component 23 are provided on the side of the pushing member 24 away from the installation portion 27.

The installation surface 271 is formed on the outer surface of the installation portion 27, and the installation surface 271 is configured to cooperate with the external structure to drive the pin 20 and install the pin 20. In the projection of the installation portion 27 perpendicular to the axial plane of the pin 20, the periphery of the installation portion 27 is tooth-shaped, so that the installation portion 27 can cooperate with an external gear driven member to drive the pin 20 to rotate.

In addition, the periphery of the installation portion 27 may be in a polygonal shape. For example, the installation portion 27 may be in a regular hexagonal shape to match structures such as a wrench.

Based on the above connector, the present application also provides an embodiment of an electrical device. The electrical device is provided with the connector as described in any of the above embodiments. The electrical device can be a car charging pile, an aerospace high current connection device, an industrial high current connection device, a vehicle device, and a base station device, etc.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

The above descriptions are only embodiments of the present application, and are not intended to limit the scope of the present application. Under the inventive concept of the present application, any equivalent structural transformations made by using the contents of the description and drawings of the present application, or direct/indirect applications in other related technical fields are included in the scope of the present application.

What is claimed is:

1. A connector, comprising:
a female end formed with a docking cavity;
a male end comprising a pin;
a collar component provided in the docking cavity or sleeved on a periphery of the pin, wherein the collar component comprises a first annular component and a second annular component; and
a pushing member provided on the pin or the female end;
wherein in response to that the pin is plugged into the docking cavity and the collar component is pushed at the docking cavity by the pushing member, the first annular component and the second annular component are configured to squeeze each other, the first annular component is configured to contract inward to be tightly cooperated with the pin, and the second annular component is configured to expand outward to be tightly cooperated with an inner wall of the docking cavity.

2. The connector according to claim 1, wherein an outer diameter of the first annular component is less than an outer diameter of the second annular component.

3. The connector according to claim 2, wherein the first annular component is independent from the second annular component, and both the first annular component and the second annular component are provided with a fracture.

4. The connector according to claim 3, wherein before the collar component is pushed by the pushing member, the first annular component is in an open-loop state; and
in response to that the collar component is pushed by the pushing member, the second annular component is in an open-loop state.

5. The connector according to claim 4, wherein one side of the first annular component facing away from the pin is formed with a slope or an arc surface, one side of the second annular component towards the pin is formed with a slope or an arc surface, the slope of the first annular component is adapted to be abutted against the slope of the second annular component, or the arc surface of the first annular component is adapted to be abutted against the arc surface of the second annular component.

6. The connector according to claim 5, wherein one side of the collar component towards the pushing member is formed with a slope or an arc surface, and one side of the pushing member towards the collar component is formed with a slope or an arc surface cooperated with the collar component.

7. The connector according to claim 5, wherein in a cross-section parallel to an axial direction of the pin, a cross-section of the first annular component is circular, elliptical or polygonal, and/or a cross-section of the second annular component is circular, elliptical or polygonal.

8. The connector according to claim 7, wherein in response to that the collar component is pushed by the pushing member, a gap is maintained between the first annular component and the docking cavity, and a gap is maintained between the second annular component and the pin.

9. The connector according to claim 8, wherein in response to that a pushing force on the collar component by the pushing member is canceled, the first annular component is configured to expand and the second annular component is configured to contract.

10. The connector according to claim 1, wherein before the collar component is pushed by the pushing member, a distance between a cross-sectional center of the first annular component and a center of the first annular component is less than a distance between a cross-sectional center of the second annular component and a center of the second annular component.

11. The connector according to claim 1, wherein the pushing member is fixed to the periphery of the pin; or
the pushing member is movably installed on the pin along an axial direction of the pin; or
the pushing member is movably installed on the female end along an axial direction of the docking cavity.

12. The connector according to claim 11, wherein the pin is provided with a front end and a rear end, the pushing member is closer to the rear end of the pin than to the front end of the pin, a stopping platform is provided on a sidewall of the front end of the pin, and the collar component is provided between the pushing member and the stopping platform.

13. The connector according to claim 11, wherein a stopping platform is protrudingly provided on a sidewall of the docking cavity, and the collar component is provided between the pushing member and the stopping platform.

14. The connector according to claim 12, wherein one side of the collar component towards the stopping platform is formed with a slope or an arc surface, and one side of the stopping platform is formed with a slope or an arc surface adapted to the collar component.

15. The connector according to claim 1, wherein at least two first annular components are provided, at least two second annular components are provided, and the first annular component and the second annular component are alternately provided along the axial direction of the pin.

16. The connector according to claim 1, wherein the collar component is made of copper or copper alloy, silver or silver alloy, aluminum or aluminum alloy or stainless steel.

17. An electrical device, comprising the connector according to claim 1.
